(19) United States
(12) Patent Application Publication
(10) Pub. No.: US 2010/0126531 A1
(43) Pub. Date: May 27, 2010

(54) METHOD AND APPARATUS FOR CLEANING SEMICONDUCTOR DEVICE FABRICATION EQUIPMENT USING SUPERCRITICAL FLUIDS

(75) Inventors: Shao-Yen KU, Jhubei City (TW); Chi-Ming Yang, Hsian-San District (TW); Tzu-Jeng Hsu, Taipei City (TW)

Correspondence Address: LOWE HAUPTMAN HAM & BERNER, LLP, 1700 DIAGONAL ROAD, SUITE 300, ALEXANDRIA, VA, 22314, US

(73) Assignee: Taiwan Semiconductor Manufacturing Company, Hsinchu (TW)

(21) Appl. No.: 12/277,839

(22) Filed: Nov. 25, 2008

(51) Int. Cl. B08B 3/08; B08B 3/10; B08B 13/00

(52) U.S. Cl. 134/26; 134/42; 134/105

(57) ABSTRACT

A process of cleaning a semiconductor device fabrication equipment is provided. In one embodiment, the semiconductor device fabrication equipment is placed in a chamber; a fluid is introduced into the chamber; a pressure and temperature of the fluid is controlled to bring the fluid to a supercritical state; the semiconductor device fabrication equipment is cleaned by having the supercritical fluid contact the semiconductor device fabrication equipment; the supercritical fluid is removed from the chamber; and the semiconductor device fabrication equipment is removed from the chamber.

### BACKGROUND

The present invention relates generally to processes and apparatuses for removing impurities from semiconductor device fabrication equipments, and more particularly to processes and apparatuses for removing impurities from semiconductor device fabrication equipments using supercritical fluids.

Semiconductor device fabrication equipments, such as FOUPs (front opening unified pod), PODs, wafer carriers, reticle carriers, etc. are often employed in the various processing, handling, and manufacturing of semiconductor devices. Contaminants from these semiconductor devices often contaminate these equipments. Contaminants such as photoresist and polymer residues often contaminate the slots in FOUPs and PODs, for example, and unless removed, these contaminants may cross-contaminate other semiconductor devices affecting device performance and reducing product yield. Currently, a variety of wet (e.g., deionized water and solvent) and dry (e.g., plasma) cleaning processes have been developed to address the broad variety of contaminants. However, with the semiconductor industry transitioning to larger wafer diameters, such as 18 inch wafers, the number of slots and slot areas in FOUPs sees a dramatic increase to support 450 mm wafers. Current cleaning methods for semiconductor device fabrication equipments are often not effective in thoroughly cleaning these equipments. FOUPs, for example given their closed design, are difficult to clean using conventional aqueous rinse methods. Moreover, as these equipments are often bulky, expensive and complex, they must be cleaned in sequential cleaning operations employing multiple vessel cleaning configurations. As such, the quantity of cleaning fluids required is quite considerable and represents a significant cost to the environment in cleaning such equipments.

For these reasons and other reasons that will become apparent upon reading the following detailed description, there is a need for an improved method of cleaning semiconductor device equipments that avoids the drawbacks associated with conventional cleaning methods.

### SUMMARY

The present invention is directed to a process of cleaning a semiconductor device fabrication equipment. In one embodiment, the semiconductor device fabrication equipment is placed in a chamber; a fluid is introduced into the chamber; a pressure and temperature of the fluid is controlled to bring the fluid to a supercritical state; the semiconductor device fabrication equipment is cleaned by having the supercritical fluid contact the semiconductor device fabrication equipment; the supercritical fluid is removed from the chamber; and the semiconductor device fabrication equipment is removed from the chamber.

### BRIEF DESCRIPTION OF THE DRAWINGS

The features, aspects, and advantages of the present invention will become more fully apparent from the following detailed description, appended claims, and accompanying drawings in which:

FIG. 1 is a schematic view of one embodiment of an apparatus for cleaning a semiconductor device fabrication equipment in accordance with a process of the present invention.

FIG. 2 is a flowchart showing one embodiment of a method for cleaning a semiconductor device fabrication equipment.

### DETAILED DESCRIPTION

In the following description, numerous specific details are set forth to provide a thorough understanding of the present invention. However, one having an ordinary skill in the art will recognize that the invention can be practiced without these specific details. In some instances, well-known processes and structures have not been described in detail to avoid unnecessarily obscuring the present invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. It should be appreciated that the following figures are not drawn to scale; rather, these figures are merely intended for illustration.

Embodiments of the present invention generally relate to methods and apparatuses using supercritical fluids in cleaning semiconductor device fabrication equipments. Examples of substances which may be used to advantage as supercritical fluids include, but are not limited to, carbon dioxide, xenon, argon, helium, krypton, nitrogen, methane, ethane, propane, pentane, ethylene, methanol, ethanol, isopropanol, isobutanol, cyclohexanol, ammonia, nitrous oxide, oxygen, silicon hexafluoride, methyl fluoride, chlorotrifluoromethane, water, and combinations thereof.

Carbon dioxide in its supercritical fluid state has been investigated as a replacement for organic solvents used in cleaning applications. Advantages of supercritical carbon dioxide over organic solvents include the unique properties of supercritical fluids and the reduced environmental risks in the use of carbon dioxide. It is removed as a gas when exposed to ambient conditions. For substances which exhibit supercritical fluid properties, when the substance is above its critical point (critical temperature and critical pressure), the phase boundary between the gas phase and liquid phase disappears, and the substance exists in a single supercritical fluid phase. In the supercritical fluid phase, a substance assumes some of the properties of a gas and some of the properties of a liquid. For example, supercritical fluids have diffusivity properties similar to gases but solvating properties similar to liquids, being able to penetrate into spaces that traditional solvents cannot reach. This is desirable for removing residue present in the slots and gaps of fine structures, such as FOUPs. Supercritical fluids, therefore have good cleaning properties.

Depending on the cleaning application, other optional components, such as co-solvents, surfactants, chelating agents, reactants, and combinations thereof, may be used in conjunction with the supercritical fluid. Examples of co-solvents include, but are not limited to, alcohols, halogenated solvents, esters, ethers, ketones, amines, amides, aromatics, aliphatic hydrocarbons, olefins, synthetic and natural hydrocarbons, organosilicones, alkyl pyrrolidones, paraffins, petroleum-based solvents, other suitable solvents, and mixtures thereof. The co-solvents may be miscible or immiscible with the supercritical fluid. Examples of chelating agents include, but are not limited to, chelating agents containing one or more amine or amide groups, such as ethylenediaminetetraacetic acid (EDTA), ethylenediaminedihyroxyphenylacetic acid (EDDHA), ethylenediamine, or methyl-formamide or other organic acids, such as iminodiacetic acid or oxalic acid. Surfactants include components having one or more polar groups and one or more non-polar groups. It is believed that the surfactants help alter the interfacial characteristics of the supercritical fluid. Examples of reactants include, but are not limited to silicon-containing compounds, oxidizing agents, carbon-containing compounds, other reactants, and combinations thereof.

Embodiments of the present invention generally relate to methods and apparatuses of using supercritical fluids in cleaning semiconductor device fabrication equipments. For the sake of simplicity, the following cleaning processes will be described with reference to liquid carbon dioxide and/or supercritical carbon dioxide.

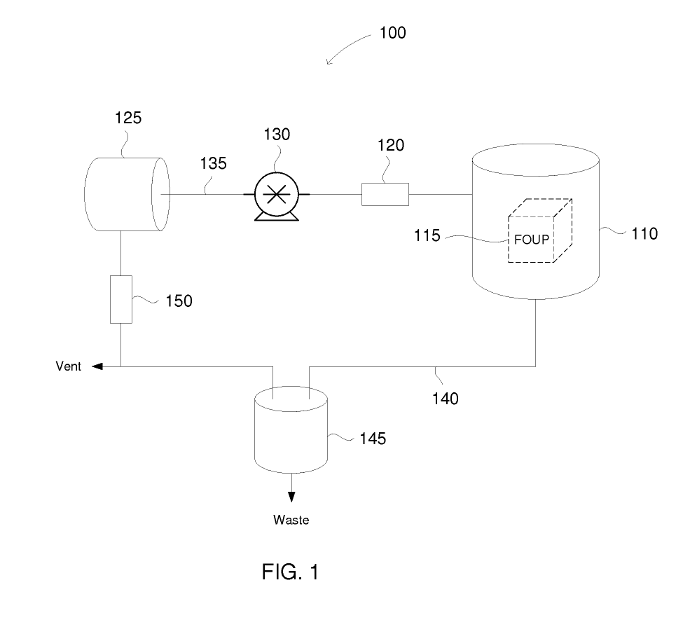

FIG. 1 is a schematic view of one embodiment of an apparatus 100 for cleaning an equipment 115 adapted to apply supercritical carbon dioxide to clean the equipment. Equipment 115 to be cleaned is introduced into processing chamber 110 wherein the equipment 115 is exposed to supercritical carbon dioxide. FIG. 1 shows the equipment 115 to be cleaned as a FOUP. It is to be understood, however, that the equipment to be cleaned may include any other equipments, such as wafer carriers, wafer cassettes, reticle carriers, PODs, reticle storage PODs (RSP), front opening storage boxes (FOSB), turntable assemblies, global cluster (GC) boxes or the like. In one embodiment, processing chamber 110 is adapted to clean FOUPs carrying 450 mm diameter substrates. Processing chamber 110 may include an apparatus (not shown) to provide access for a robot to transfer and receive FOUPs between cleaning processes. To ensure that the supercritical carbon dioxide remains in the supercritical state during processing, process chamber 110 maintains the carbon dioxide at a certain pressure and temperature. In one embodiment, the processing chamber 110 is maintained at a pressure in the range of between about 500 psi and about 5,000 psi. In another embodiment, the pressure within the processing chamber 110 is in the range of between about 1,000 psi and about 4,000 psi. In yet another embodiment, the pressure within processing chamber 110 is about 3,000 psi. In one embodiment, the temperature within processing chamber 110 is maintained in a range of between about 0° C. and about 100° C. In another embodiment, the temperature within processing chamber 110 is maintained in a range of between about 40° C. and about 80° C. In yet another embodiment, the temperature within processing chamber 110 is in the range of about 60° C.

Since it is critical that these thermodynamic conditions be maintained during the process of the present invention, processing chamber 110 may be heated and/or controlled by a heating unit 120 which has the capability to heat processing chamber 110 and/or monitor the temperature in processing chamber 110. In one embodiment, heating unit 120 is disposed proximate or inside the walls of processing chamber 110 and may comprise resistive heating elements and/or other heating devices. In general, apparatuses for heating and monitoring a control chamber are well-known to those skilled in the art and will not be described in further details.

Either liquid or supercritical carbon dioxide may be provided into processing chamber 110 from a fluid supply source 125. As shown in FIG. 1, a pump 130 may be disposed on fluid supply line 135 between the fluid supply source 125 and the entrance to processing chamber 110 for delivering liquid carbon dioxide from the fluid supply source 125 into the enclosure of the processing chamber 110. Liquid carbon dioxide may also be first pressurized by pump 130 to bring it to a desired pressure within the processing chamber 110. The processing chamber is closed and heating unit 120 heats the carbon dioxide to a desired temperature so that it is brought to a supercritical state. In another embodiment, liquid carbon dioxide is delivered to chamber 110 as a supercritical fluid (i.e. as opposed to delivering the liquid carbon dioxide to the chamber 110 and setting conditions inside the chamber to bring the liquid to a supercritical fluid state).

The supercritical carbon dioxide is circulated within the processing chamber 110 and brought into contact with the equipment 115 to be cleaned to remove any waste layer on the equipment 115. The waste layer may be various waste layers that accumulate on equipment 115, such as on or about the slots of equipment 115 and may include, but not limited to, chemical mechanical polishing residues, post-ion implantation residues, reactive ion etch residues, post-ash residues, photoresists, or mixtures thereof. After the equipment has been cleaned with the supercritical carbon dioxide for a desired time period, an outlet (not shown) in the processing chamber 110 is opened, the chamber is depressurized, and the carbon dioxide and any waste material may then be channeled via a waste disposal line 140 to a storage tank 145 for storage or recycling or vented or released to the atmosphere. Cleaning apparatus 100 may optionally include a cooling unit 150 for lowering the temperature of the carbon dioxide prior to its release to the atmosphere. In one embodiment, releasing the pressure of the processing chamber 110 causes the carbon dioxide at a supercritical fluid state to be at a gas state which can be easily removed from the chamber 110. The cleaned equipment 115 is thereafter removed from the processing chamber 110. The process of removing the cleaned equipment 115 and receiving another equipment to be cleaned for placement into the chamber 110 is preferably automated.

While embodiments of cleaning apparatus 100 according to the present invention have been described with reference to FIG. 1 above, it is understood that various modifications, structures, and changes may be made thereto without departing from the broader spirit and scope of the present invention, as set forth in the claims. As an example, those skilled in the art understands that fluid transfer devices such as pumps and compressors may be inserted into one or more of the various lines as needed in order to facilitate fluid transfer. The lines may be selected from a group comprising piping, conduit, and other means of fluid communication that can withstand system temperature and pressure. One who is skilled in the art will also understand that where one line has been shown in a given embodiment, multiple lines may be employed to provide, for example, supply and return piping. Additionally, valves may reside in one or more lines as appropriate.

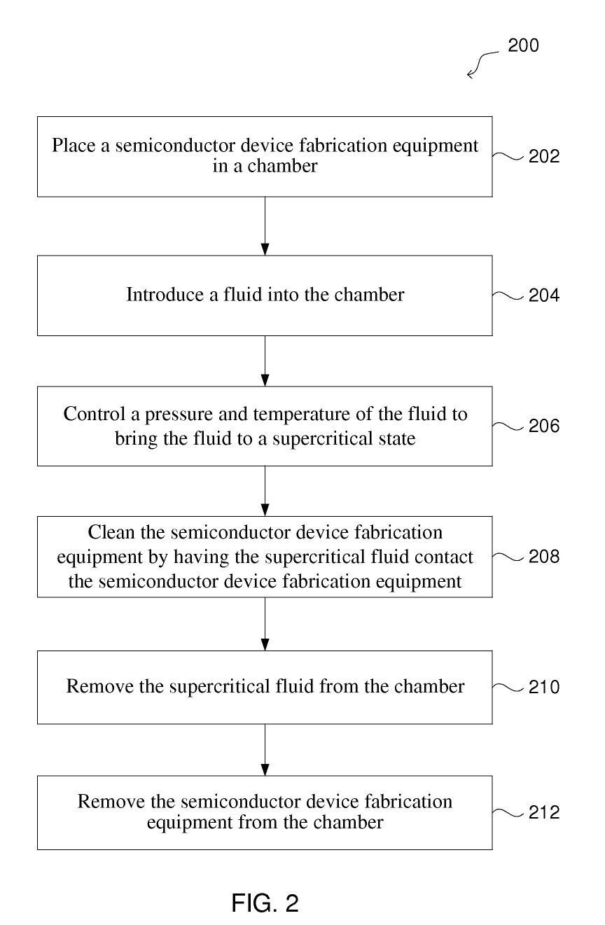

FIG. 2 is a flowchart showing a method for cleaning a semiconductor device fabrication equipment according to one embodiment of the present invention. The method 200 begins at step 202 by placing a semiconductor device fabrication equipment in a chamber. At step 204, a fluid is introduced into the chamber. At step 206, a pressure and temperature of the fluid is controlled to bring the fluid to a supercritical state. At step 208, the semiconductor device fabrication equipment is cleaned by having the supercritical fluid contact the equipment. At step 210, the supercritical fluid is removed from the chamber. At step 212, the equipment is removed from the chamber.

What is claimed is:

1. A process of cleaning a semiconductor device fabrication equipment, the process comprising:
placing the semiconductor device fabrication equipment in a chamber;
introducing a supercritical fluid into the chamber;
cleaning the semiconductor device fabrication equipment by having the supercritical fluid contact the semiconductor device fabrication equipment;
removing the supercritical fluid from the chamber; and
removing the semiconductor device fabrication equipment from the chamber.

2. The process of claim 1, wherein the semiconductor device fabrication equipment is a wafer carrier, wafer FOUP, wafer cassette, reticle carrier, POD, reticle storage POD (RSP), front opening storage box (FOSB), turntable assembly, or global cluster (GC) box.

3. The process of claim 1, wherein the supercritical fluid is a substance selected from the group consisting of carbon dioxide, nitrogen, argon, xenon, helium, krypton, methane, ethane, propane, pentane, ethylene, methanol, ethanol, isopropanol, isobutanol, cyclohexanol, ammonia, nitrous oxide, oxygen, silicon hexafluoride, methyl fluoride, chlorotrifluoromethane, water, and combinations thereof.

4. The process of claim 1, wherein the cleaning occurs at a pressure in the range of between about 500 psi and about 5,000 psi and at a temperature in the range of between about 0° C. and about 100° C.

5. The process of claim 1, further comprising introducing a co-solvent to the supercritical fluid in the chamber.

6. The process of claim 1, further comprising depressurizing the chamber.

7. The process of claim 1, wherein a waste layer is on the semiconductor device fabrication equipment, and wherein the cleaning the semiconductor device fabrication equipment comprises removing the waste layer from the semiconductor device fabrication equipment.

8. The process of claim 7, wherein the supercritical fluid and the waste layer are removed to a storage tank.

9. The process of claim 1, wherein the removing the semiconductor device fabrication equipment from the chamber is automated.

10. A process of cleaning a semiconductor device fabrication equipment, the process comprising:
placing the semiconductor device fabrication equipment in a chamber;
introducing a fluid into the chamber;
controlling a pressure and temperature of the fluid to bring the fluid to a supercritical state;
cleaning the semiconductor device fabrication equipment by having the supercritical fluid contact the semiconductor device fabrication equipment;
removing the supercritical fluid from the chamber; and
removing the semiconductor device fabrication equipment from the chamber.

11. The process of claim 10, wherein the semiconductor device fabrication equipment is a wafer carrier, wafer FOUP, wafer cassette, reticle carrier, POD, reticle storage POD (RSP), front opening storage box (FOSB), turntable assembly, or global cluster (GC) box.

12. The process of claim 10, wherein the fluid is a substance selected from the group consisting of carbon dioxide, nitrogen, argon, xenon, helium, krypton, methane, ethane, propane, pentane, ethylene, methanol, ethanol, isopropanol, isobutanol, cyclohexanol, ammonia, nitrous oxide, oxygen, silicon hexafluoride, methyl fluoride, chlorotrifluoromethane, water, and combinations thereof.

13. The process of claim 10, wherein the cleaning occurs at a pressure in the range of between about 500 psi and about 5,000 psi and at a temperature in the range of between about 0° C. and about 100° C.

14. The process of claim 10, further comprising introducing a co-solvent to the supercritical fluid in the chamber.

15. The process of claim 10, wherein a waste layer is on the semiconductor device fabrication equipment, and wherein the cleaning the semiconductor device fabrication equipment comprises removing the waste layer from the semiconductor device fabrication equipment.

16. The process of claim 15, wherein the supercritical fluid and the waste layer are removed to a storage tank.

17. The process of claim 10, wherein the removing the semiconductor device fabrication equipment from the chamber is automated.

18. An apparatus for cleaning a semiconductor device fabrication equipment, the apparatus comprising:
a fluid supply source;
a chamber coupled to the fluid supply source, the chamber for placing the semiconductor device fabrication equipment therein, and further wherein the chamber for receiving a fluid from the fluid supply source for cleaning the semiconductor device fabrication equipment;
a heating and pressuring system for bringing the fluid to a supercritical state; and
a storage tank coupled to the chamber, the storage tank for collecting contaminated supercritical fluid from the chamber.

19. The apparatus of claim 18, wherein the semiconductor device fabrication equipment is a wafer carrier, wafer FOUP, wafer cassette, reticle carrier, POD, reticle storage POD (RSP), front opening storage box (FOSB), turntable assembly, or global cluster (GC) box.

20. The apparatus of claim 18, wherein the fluid is a substance selected from the group consisting of carbon dioxide, nitrogen, argon, xenon, helium, krypton, methane, ethane, propane, pentane, ethylene, methanol, ethanol, isopropanol, isobutanol, cyclohexanol, ammonia, nitrous oxide, oxygen, silicon hexafluoride, methyl fluoride, chlorotrifluoromethane, water, and combinations thereof.
